(19) United States
(12) Patent Application Publication
(10) Pub. No.: US 2026/0061435 A1
(43) Pub. Date: Mar. 5, 2026

(54) WATER OUTLET DEVICE, WATER OUTLET ASSEMBLY, AND SHOWER DEVICE

(71) Applicant: FUJIAN DOMOO SANITARY WARE TECHNOLOGY CO., LTD., Nan'an (CN)

(72) Inventors: Xiaofa Lin, Nan'an (CN); Xiaoshan Lin, Nan'an (CN); Mingchi Jiang, Nan'an (CN); Jiaxin Liu, Nan'an (CN); Pansheng Liang, Nan'an (CN); Xiaoqing Deng, Nan'an (CN); Qiqiao Liu, Nan'an (CN)

(73) Assignee: FUJIAN DOMOO SANITARY WARE TECHNOLOGY CO., LTD., Nan'an (CN)

(21) Appl. No.: 18/973,750

(22) Filed: Dec. 9, 2024

(30) Foreign Application Priority Data
Aug. 29, 2024 (CN) 202422115979.9

(51) Int. Cl. B05B 1/18; H01R 13/66

(52) U.S. Cl. CPC B05B 1/18; H01R 13/6675

(57) ABSTRACT

The application discloses a water outlet device, a water outlet assembly, and a shower device. The water outlet device includes a water outlet main body, the water outlet main body is provided with an installation hole, and the installation hole is configured for detachably installing a functional module having a predetermined function. A hole wall of the installation hole is provided with multiple connection terminals for contacting with docking contact points on the functional module and the connection terminals are configured to supply power and/or transmit signals to the functional module.

### CROSS-REFERENCE TO RELATED APPLICATION

The present application claims priority to Chinese Patent Application No. 202422115979.9 filed to the CNIPA on Aug. 29, 2024. The contents of the above-identified application are incorporated into the present application by reference.

### TECHNICAL FIELD

The application relates to the field of bathroom technologies, and more particularly relates to a water outlet device, a water outlet assembly, and a shower device.

### BACKGROUND

In an existing intelligent water outlet device, for example, a shower, it is usually a separate digital display mode shower, a separate lighting mode shower, and a separate music shower, and intelligent modules cannot be disassembled and interchanged. Therefore, various intelligent modes of a shower apparatus cannot be flexibly matched and combined, thus failing to meet requirements of customers for various functions of an intelligent shower.

### SUMMARY

An embodiment of the application provides a water outlet device, a water outlet assembly and a shower device, so as to solve a problem that various intelligent modes in an existing water outlet device cannot be flexibly matched and combined.

An embodiment of the present application provides a water outlet device, including a water outlet main body, the water outlet main body being provided with an installation hole, and the installation hole being configured for detachably installing a functional module having a predetermined function. A hole wall of the installation hole is provided with multiple connection terminals for contacting with docking contact points on the functional module and the connection terminals are configured to supply power and/or transmit signals to the functional module.

In one embodiment, the water outlet device further includes a power supply module installed on the water outlet main body, and the connection terminals include a power-on terminal connected to the power supply module.

In one embodiment, the power supply module is a hydroelectric generator.

In one embodiment, the water outlet device further includes a signal detection device installed on the water outlet main body for acquiring a predetermined signal, the multiple connection terminals further include a signal terminal connected to the signal detection device, and the signal terminal is configured to transmit information detected by the signal detection device to the functional module.

In one embodiment, the multiple connection terminals are configured to elastically extend out of the hole wall of the installation hole and to be elastically retractable, and when the functional module is installed in the installation hole, the connection terminals are in a retracted state and are docked with the docking contact points of the functional module.

In one embodiment, the hole wall of the installation hole is provided with a sealing ring surrounding the multiple connection terminals, and when the functional module is installed in the installation hole, the sealing ring is pressed by the functional module.

In one embodiment, the installation hole is a through hole provided in the water outlet main body, and the functional module may be removed from the installation hole by pressing a rear end surface of the functional module.

An embodiment of the present application further provides a water outlet assembly, including at least one functional module and the water outlet device as described above, and each functional module is configured to be detachably installed in the installation hole of the water outlet device.

In one embodiment, the at least one functional module includes at least one of a digital display module, an audio module, a lighting module and a massage module.

In one embodiment, the hole wall of the installation hole is provided with a positioning hole, and the functional module is provided with an elastic positioning bead, and when the functional module is installed in the installation hole, the positioning bead may be elastically inserted into the positioning hole; and/or, a guide structure for guiding the installation of the functional module is provided between the hole wall of the installation hole and the functional module.

In one embodiment, one of the hole wall of the installation hole and an outer periphery of the functional module is provided with an annular groove, and the other of the hole wall of the installation hole and the outer periphery of the functional module is provided with a flexible fixation ring. When the functional module is installed in the installation hole, the fixation ring is in interference fit with the annular groove.

In one embodiment, the water outlet device is a shower.

An embodiment of the present application also provides a shower device and the shower device includes the water outlet assembly as described above.

According to a technical solution provided by an embodiment of the present application, by detachably installing the functional module in the installation hole, various functional modules may be matched on the water outlet device as needed. For example, the functional module may be a digital display module, a lighting module, an audio module or a massage module. Various functional modules matched on the water outlet device may meet various functional requirements of customers for the intelligent water outlet device.

Additional features and advantages of the present application will be set forth in the description which follows, and in part will become apparent from the description, or may be learned by practice of the present application. The objects and other advantages of the present application can be realized and obtained by the structures particularly indicated in the description and drawings.

### BRIEF DESCRIPTION OF THE DRAWINGS

The drawings are used for providing a further understanding of technical solutions of the present application, and constitute a part of the specification, and together with the embodiments of the present application, are used to explain the technical solutions of the present application, but do not constitute limitations on the technical solutions of the present application.

FIG. 1 is a schematic structural diagram of a shower according to an embodiment of the present application.

FIG. 2 is an enlarged view at A in FIG. 1.

FIG. 3 is a schematic structural diagram of the shower shown in FIG. 1 as viewed from another side.

FIG. 4 is an enlarged view at B in FIG. 3.

FIG. 5 is a schematic structural diagram taken at a connection terminal in FIG. 4.

FIG. 6 is a schematic structural diagram of a functional module installed in a shower according to an embodiment of the present application.

FIG. 7 is a schematic structural diagram of the structure shown in FIG. 6 in an exploded state.

FIG. 8 is a schematic cross-sectional diagram of the structure shown in FIG. 6.

FIG. 9 is an enlarged view at C in FIG. 8.

FIG. 10 is a schematic structural diagram of a water inlet module according to an embodiment of the present application.

FIG. 11 is a schematic structural diagram of a functional module according to an embodiment of the present application.

FIG. 12 is a schematic structural diagram of the functional module shown in FIG. 11 as viewed from another side.

1-water outlet main body; 11-shower head; 12-connection pipe; 13-installation hole; 131-connection terminal; 132-sealing ring; 133-spring; 134-positioning hole; 135-guide groove; 136-annular groove; 137-opening; 2-water inlet module; 21-water inlet pipe; 22-hydroelectric generator; 23-temperature sensor; 3-functional module; 31-docking contact point; 32-positioning bead; 33-guide block; 34-fixation ring.

### DETAILED DESCRIPTION

In order to make the objectives, technical solutions and advantages of the present application clearer, embodiments of the present application will be described in detail below in connection with the drawings. It should be noted that the embodiments in the present application and the features in the embodiments may be arbitrarily combined with each other provided that there is no conflict.

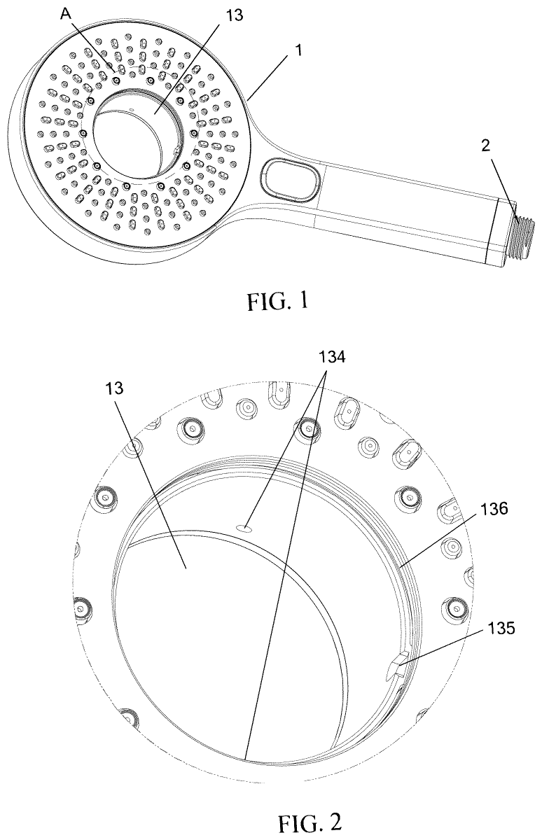

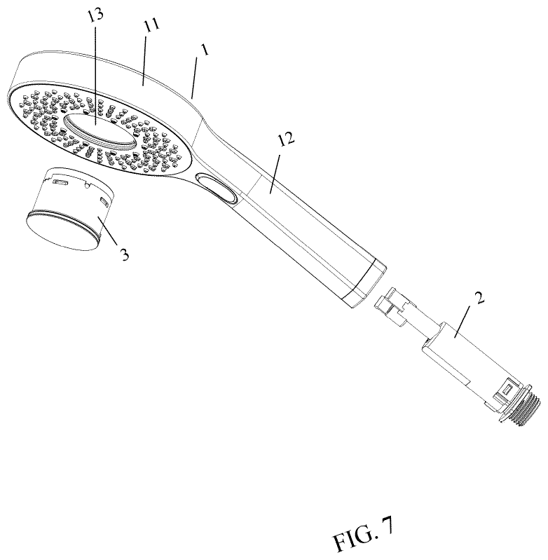

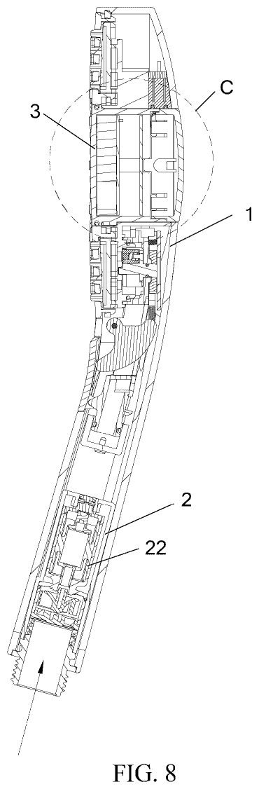

An embodiment of the present application provides a water outlet device, as shown in FIGS. 1 to 8, including: a water outlet main body 1. The water outlet main body 1 is provided with an installation hole 13, and the installation hole 13 is configured for detachably installing a functional module 3 having a predetermined function. A hole wall of the installation hole 13 is provided with multiple connection terminals 131 for connecting to docking contact points 31 on the functional module 3, and the connection terminals 131 are configured to supply power and/or transmit signals to the functional module 3. The water outlet device may be a shower, a faucet, or the like, and the water outlet device shown in FIGS. 1 to 8 is a shower.

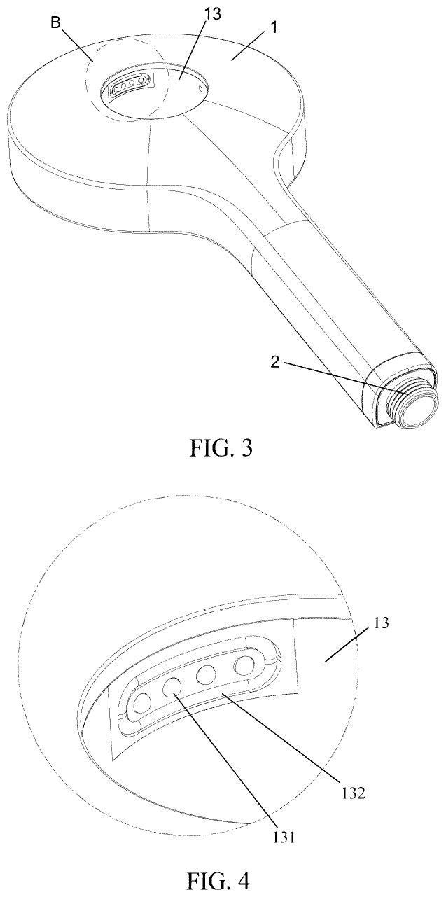

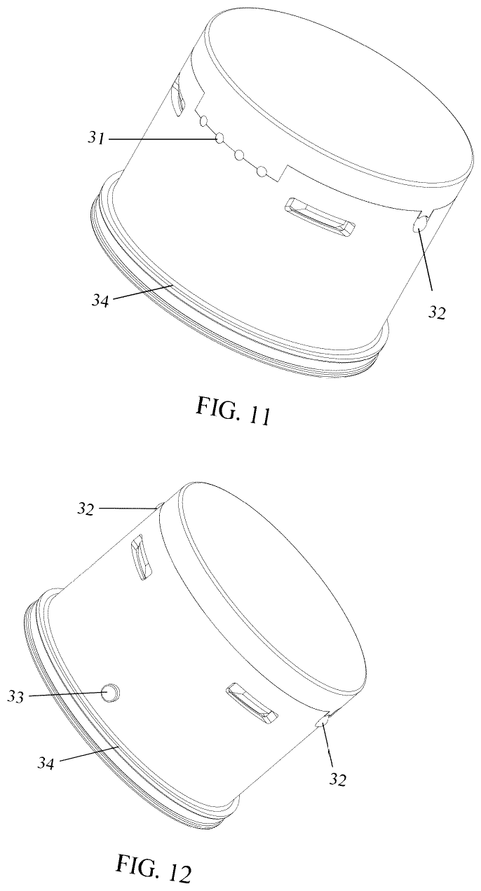

In an example shown in FIGS. 3 and 4, four connection terminals 131 are provided on the hole wall of the installation hole 13, and when the functional module 3 shown in FIG. 11 is installed in the installation hole 13, for example, the four connection terminals 131 may be in contact with four docking contact points 31 provided on the functional module 3, respectively. It is understood that a quantity of the connection terminals 131 is not limited, and the quantity of the connection terminals 131 may be set according to the power-on demand or the signal transmission demand. Various functional modules 3 may be matched in the installation hole 13, and when a quantity of the docking contact points 31 of the matched functional module 3 is less than the quantity of the connection terminals 131, the docking contact points 31 on the functional module 3 may be in contact with the corresponding connection terminals 131. For example, if the functional module 3 only needs to be powered on, only two contact points on the functional module 3 are correspondingly contact with two connection terminals 131, or if the functional module 3 needs to receive signals, the functional module 3 is only connected to the connection terminals 131 for signal transmission.

According to a technical solution provided by an embodiment of the present application, by detachably installing the functional module 3 in the installation hole 13, various functional modules can be matched with the water outlet device according to the needs. For example, the functional module 3 may be a digital display module, a lighting module, an audio module, or a massage module. When the functional module is installed on the water outlet device, for example, when the digital display module is installed on the shower, water outlet temperature, bathing time, water outlet flow rate and other information may be displayed through the digital display module. When the lighting module is installed on the shower, the shower may emit light while showering. When the audio module is installed on the shower, it may be possible to listen to music or other audio while showering. When the massage module (a massage head with a message function) is installed on the shower, the shower may be used for massage. Therefore, installing various functional modules on the water outlet main body 1 may meet various functional requirements of customers for the water outlet device. The functional module 3 may be connected to a terminal device such as a mobile phone and the terminal device such as a mobile phone controls the functional module 3.

In one embodiment, the water outlet device further includes a power supply module installed on the water outlet main body 1, and the connection terminal 131 includes a power-on terminal connected to the power supply module. When the functional module 3 is installed on the water outlet main body 1, power can be supplied through the power-on terminal in the installation hole 13. Alternatively, some functional modules 3 with their own batteries or with charging functions may also be installed in the installation hole 13 (that is, the power-on terminal on the water outlet device does not need to be supplied with power).

In one example, the power supply module is a hydroelectric generator 22. When water flows to the water outlet device, the hydroelectric generator 22 generates electricity by hydroelectric power, so that the hydroelectric generator 22 may supply power to the functional module 3 installed in the installation hole 13. Alternatively, the power supply module may be a battery installed on the water outlet main body 1.

As shown in FIGS. 7 to 10, the water outlet device is a shower, the water outlet main body 1 includes a shower head 11 and a connection pipe 12 connected with the shower head 11, an installation hole 13 for installing the functional module 3 is provided in the shower head 11, and a water inlet module 2 is installed in the connection pipe 12. The water inlet module 2 includes a water inlet pipe 21 for supplying water to the shower head 11, and a hydroelectric generator 22 is provided in the water inlet pipe 21. When water flows from an inlet end of the water inlet pipe 21 into the shower head 11 along the water inlet pipe 21, the hydroelectric generator 22 generates electricity by means of hydroelectric power. It is a prior art that the hydroelectric generator is provided in the water inlet pipe 21 to generate electricity by means of hydroelectric power, which will not be described in detail. It can be understood that the installation hole 13 for installing the functional module 3 is not limited to being provided on the shower head 11, but may also be provided at other positions of the water outlet device, such as on the connection pipe 12 connected to the shower head. When the water outlet device is a faucet or other type of water outlet device, the installation hole 3 may be provided in a suitable position as desired.

Since the water power of the water outlet device (for example, a shower) is weak, the power supply of the hydroelectric generator 22 can be supplied to a functional module such as a digital display module or a lighting module having a relatively low power, and the functional module 3 such as an audio module or a massage module may be installed in the water outlet device by having a battery or being charged.

In one embodiment, the water outlet device further includes a signal detection device provided on the water outlet main body 1 for acquiring a predetermined signal, and the multiple connection terminals 131 further include signal terminals connected to the signal detection device. The signal terminals are configured to transmit information detected by the signal detection device to the functional module 3.

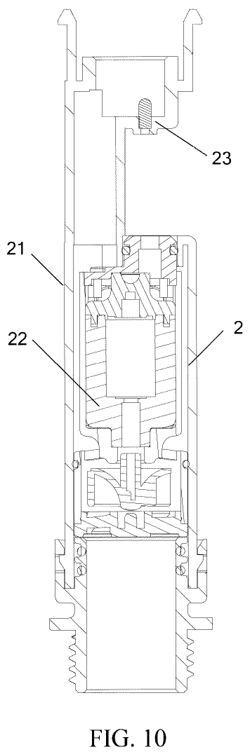

In an example shown in FIG. 10, the signal detection device includes a temperature sensor 23 installed on the water inlet pipe 21 of the water inlet module 2, and temperature information of the water in the water outlet device is acquired by the temperature sensor 23. The temperature sensor 23 is connected to a signal terminal in the connection terminals 131 in the installation hole 131, so as to transmit the information to a specific functional module 3 (e.g. a digital display module) through a signal terminal, and the temperature information of the water is displayed through the functional module 3. In addition, the water outlet device may be provided with a flow detection device for detecting the water flow rate or a timer for timing the water outlet time, and the detected flow rate information or time information may be transmitted to the functional module 3 through the connection terminal 131.

In one embodiment, the multiple connection terminals 131 are configured to elastically extend out of the hole wall of the installation hole 13 and to be elastically retractable. When the functional module 3 is installed in the installation hole 13, the connection terminal 131 is pressed and retracted by the functional module 3 so that the functional module 3 may be installed in the installation hole 13, and the connection terminal 131 is in elastic contact with the docking contact point 31 of the functional module 3 to ensure the reliability of the contact.

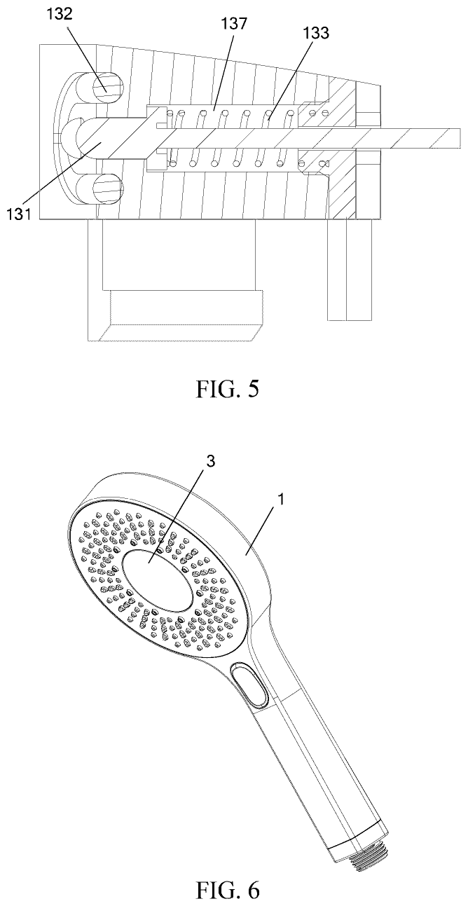

As shown in FIGS. 4 and 5, an opening 137 is provided in the hole wall of the installation hole 13, and a spring 133 and a connection terminal 131 are provided in the opening 137. The connection terminal 131 may extend out of the opening 137 under an elastic force of the spring 133 and retract into the opening 137 under a pressing action of the functional module 3.

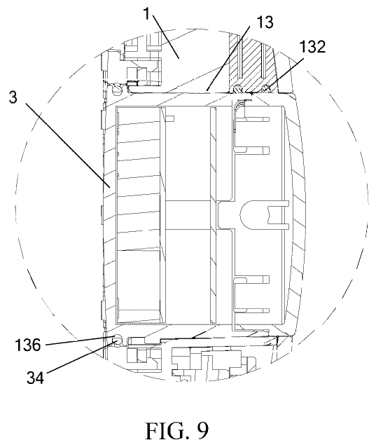

In one embodiment, the hole wall of the installation hole 13 is provided with a sealing ring 132 surrounding the multiple connection terminals 131, as shown in FIGS. 4 and 5, the multiple connection terminals 131 are located in an area surrounded by the sealing ring 132, and when the functional module 3 is installed in the installation hole 13, the sealing ring 132 is pressed by the functional module 3. Referring to FIG. 9, the pressed sealing ring 132 may seal a gap between the functional module 3 and the hole wall of the installation hole 13, so that the connection terminal 131 may be sealed in the area surrounded by the sealing ring 132. In this way, water will not enter the area, thereby realizing the effective waterproofing of the multiple connection terminals 131, and avoiding the issue of contact failure caused by corrosion of the connection terminal 131 in a high temperature and high humidity environment.

In one embodiment, the installation hole 13 is a through hole provided in the water outlet main body 1, and the functional module 3 may be removed from the installation hole 13 by pressing a rear end surface of the functional module 3. The functional module 3 may be fixed in the installation hole 13 by means of interference fit with the installation hole 13.

In one embodiment, as shown in FIG. 2, the hole wall of the installation hole 13 is provided with a positioning hole 134, and the functional module 3 is provided with an elastic positioning bead 32 (see FIGS. 11 and 12), and when the functional module 3 is installed in the installation hole 13, the positioning bead 32 may be elastically inserted into the positioning hole 134. In this way, when the functional module 3 is installed, the matching of the positioning bead 32 and the positioning hole 134 may generate a clicking sound and a certain hand feel, which may serve as a reminder for proper installation. The positioning bead 32 may be arranged in a manner similar to the connection terminal 131, and an opening is provided in the functional module 3, and a spring is provided in the opening to apply an elastic force to the positioning bead 32.

When the functional module 3 is installed in the installation hole 13, a guide structure for guiding the installation of the functional module 3 is provided on the hole wall of the installation hole 13 so that the docking contact point 31 may correspondingly contact with the connection terminal 131 and the positioning bead 32 may correspond to the positioning hole 134. As shown in FIG. 2, a guide groove 135 is provided on the hole wall of the installation hole 13, a guide block 33 is provided on the functional module 3 shown in FIG. 12, and a fit between the guide block 33 and the guide groove 135 plays a guiding role for the installation of the functional module 3. Alternatively, the guide block may be provided on the hole wall of the installation hole 13, and the guide groove may be provided on the functional module.

In one embodiment, as shown in FIG. 2, an annular groove 136 is provided on the hole wall of the installation hole 13, and a flexible fixation ring 34 is provided on an outer peripheral surface of the functional module 3. When the functional module 3 is installed in the installation hole 13, the fixation ring 34 is in interference fit with the annular groove 136, thereby realizing the fixation of the functional module 3 in the installation hole 13. It will be appreciated that a flexible fixation ring 34 may also be provided on the hole wall of the installation hole 13, and an annular groove 136 may be provided on an outer periphery of the functional module 3.

An embodiment of the present application also provides a water outlet assembly including at least one functional module 3 and the water outlet device as described above. Each functional module 3 is configured to be detachably installed in an installation hole 13 of the water outlet device.

The at least one functional module includes at least one of a digital display module, an audio module, a lighting module, and a massage module.

In one embodiment, the water outlet device is a shower.

In one example, with reference to the above description, the hole wall of the installation hole 13 may be provided with a positioning hole 134, and the functional module 5 may be provided with an elastic positioning bead 32, and when the functional module 3 is installed in the installation hole 13, the positioning bead 32 is elastically inserted into the positioning hole 134. A guide structure for guiding the installation of the functional module 3 may be provided between the hole wall of the installation hole 13 and the functional module 3. Further, with reference to the above description, an annular groove 136 may be provided on one of the hole wall of the installation hole 13 and the outer periphery of the functional module 3, and a flexible fixation ring 34 may be provided on the other of the hole wall of the installation hole 13 and the outer periphery of the functional module 3, and the functional module 3 may be fixed to the installation hole 13 by an interference fit between the fixation ring 34 and the annular groove 136.

An embodiment of the present application also provides a shower device including the water outlet device as described above.

In the description of the present application, it should be noted that the orientation or position relationships indicated by the terms “upper”, “lower”, “one side”, “the other side”, “one end”, “the other end”, “side”, “relative”, “four corners”, “periphery”, “□ structure” and the like are based on the orientation or position relationships shown in the drawings, which are only for convenience of describing the present application and simplifying the description, rather than indicating or implying that the structure referred has the specific orientation, or is constructed and operated in the specific orientation, and thus cannot be interpreted as a limitation on the present application.

In the description of the embodiments of the present application, unless otherwise explicitly specified and limited, the terms “connection”, “direct connection”, “indirect connection”, “fixed connection”, “mounting” and “assembly” should be understood in a broad sense. For example, it may be a fixed connection, a detachable connection or an integrated connection; and the terms “mounting”, “connection” and “fixed connection” may be a direct connection, or an indirect connection through an intermediate medium, or may be an internal communication between two elements. For those of ordinary skills in the art, the specific meanings of the aforementioned terms in the present application may be understood according to specific situations.

Although the disclosed implementations of the present application are described above, the described contents are only the implementations adopted for facilitating understanding of the present disclosure, which are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

1. A water outlet device, comprising a water outlet main body, wherein the water outlet main body is provided with an installation hole, the installation hole is configured for detachably installing a functional module having a predetermined function; wherein a hole wall of the installation hole is provided with a plurality of connection terminals for contacting with docking contact points on the functional module, and the connection terminals are configured to supply power and/or transmit signals to the functional module.

2. The water outlet device according to claim 1, further comprising a power supply module installed on the water outlet main body, wherein the connection terminals comprise a power-on terminal connected to the power supply module.

3. The water outlet device according to claim 2, wherein the power supply module is a hydroelectric generator.

4. The water outlet device according to claim 1, further comprising a signal detection device installed on the water outlet main body for acquiring a predetermined signal, wherein the plurality of connection terminals further comprise a signal terminal connected to the signal detection device, and the signal terminal is configured to transmit information detected by the signal detection device to the functional module.

5. The water outlet device according to claim 1, wherein the plurality of connection terminals are configured to elastically extend out of the hole wall of the installation hole and to be elastically retractable, and when the functional module is installed in the installation hole, the connection terminals are in a retracted state and are docked with the docking contact points of the functional module.

6. The water outlet device according to claim 5, wherein the hole wall of the installation hole is provided with a sealing ring surrounding the plurality of connection terminals, and when the functional module is installed in the installation hole, the sealing ring is pressed by the functional module.

7. The water outlet device according to claim 1, wherein the installation hole is a through hole provided in the water outlet main body, and the functional module is able to be removed from the installation hole by pressing a rear end surface of the functional module.

8. A water outlet assembly, comprising at least one functional module and the water outlet device according to claim 1, wherein each functional module is configured to be detachably installed in the installation hole of the water outlet device.

9. The water outlet assembly according to claim 8, wherein the at least one functional module comprises at least one of a digital display module, an audio module, a lighting module, and a massage module.

10. The water outlet assembly according to claim 8, wherein the hole wall of the installation hole is provided with a positioning hole, and the functional module is provided with an elastic positioning bead, and when the functional module is installed in the installation hole, the positioning bead is able to be elastically inserted into the positioning hole; and/or
a guide structure for guiding the installation of the functional module is provided between the hole wall of the installation hole and the functional module.

11. The water outlet assembly according to claim 8, wherein one of the hole wall of the installation hole and an outer periphery of the functional module is provided with an annular groove, and the other of the hole wall of the installation hole and the outer periphery of the functional module is provided with a flexible fixation ring, and when the functional module is installed in the installation hole, the fixation ring is in interference fit with the annular groove.

12. The water outlet assembly according to claim 8, wherein the water outlet device is a shower.

13. A shower device, comprising the water outlet assembly according to claim 8.

14. The water outlet device according to claim 2, wherein the installation hole is a through hole provided in the water outlet main body, and the functional module is able to be removed from the installation hole by pressing a rear end surface of the functional module.

15. The water outlet device according to claim 3, wherein the installation hole is a through hole provided in the water outlet main body, and the functional module is able to be removed from the installation hole by pressing a rear end surface of the functional module.

16. The water outlet device according to claim 4, wherein the installation hole is a through hole provided in the water outlet main body, and the functional module is able to be removed from the installation hole by pressing a rear end surface of the functional module.

17. The water outlet device according to claim 5, wherein the installation hole is a through hole provided in the water outlet main body, and the functional module is able to be removed from the installation hole by pressing a rear end surface of the functional module.

18. The water outlet device according to claim 6, wherein the installation hole is a through hole provided in the water outlet main body, and the functional module is able to be removed from the installation hole by pressing a rear end surface of the functional module.

19. A water outlet assembly, comprising at least one functional module and the water outlet device according to claim 2, wherein each functional module is configured to be detachably installed in the installation hole of the water outlet device.

20. A water outlet assembly, comprising at least one functional module and the water outlet device according to claim 3, wherein each functional module is configured to be detachably installed in the installation hole of the water outlet device.
